(19) United States
(12) Patent Application Publication
(10) Pub. No.: US 2004/0150504 A1
(43) Pub. Date: Aug. 5, 2004

(54) Resettable ferromagnetic thermal switch

(76) Inventor: Warren Baxter Nicholson, El Paso, TX (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/354,293

(22) Filed: Jan. 30, 2003

(51) Int. Cl. H01H 71/40

(52) U.S. Cl. 337/54; 337/90; 337/98; 337/344; 337/366

(57) ABSTRACT

A resettable thermal switch utilizing the principle that the permeability of a ferromagnetic material is sensitive to temperature variations in the vicinity of the Curie temperature. The resettable ferromagnetic thermal switch includes a resilient arm having a ferromagnetic aspect associated therewith (inherently or by attachment), an electrical contact including a stationary contact component and a movable contact component located at a distal location of the resilient arm, and a magnet located on one side of the resilient arm. The resilient arm has a predetermined inherent spring force urging the movable contact component toward or away from the stationary contact component depending on whether the electrical contact is to be spring biased closed or spring biased open, respectively. The magnet is located to provide a magnetic attraction force with the temperature dependent permeability of the ferromagnetic aspect in opposition to the inherent spring force.

### TECHNICAL FIELD

The present invention relates to thermal switches which open or resettably open and close dependent upon changes in temperature. More particularly, the present invention is related to a resettable thermal switch which actuates upon the temperature thereof crossing predetermined threshold temperatures in the vicinity of the Curie temperature of a selected ferromagnetic material.

### BACKGROUND OF THE INVENTION

Thermal switches are electrical switches which open or close in response to the switch encountering a predetermined temperature. In this regard, there is great need for thermal limit switches to protect all types of equipment from thermal overload.

One example of a common thermal switch is a thermal link limit switch which is composed of a temperature sensitive alloy and which carries, in series, electrical current of a circuit, the circuit including one or more devices to be protected. When the temperature of the material of the thermal link rises above a predetermined highest allowable temperature, the alloy melts and thereby opens the circuit. Since the thermal link is sacrificed, this type of thermal limit switch must be replaced after each operative event in which the temperature rises above the predetermined thermal limit, much like an electrical fuse.

A second type of thermal switch is a resettable thermal switch in which the contact trips open or closed upon reaching a first predetermined temperature, then automatically retrips upon reaching a second predetermined temperature. The first and second threshold temperatures can be made close or far apart depending a predetermined hysteresis that is proper for operation of the included circuit. The threshold temperatures can be caused by ambient temperature changes of the surroundings or be caused by resistive heating due to current flowing through the resettable thermal switch.

An example of a resettable thermal switch is a common thermostat for regulating furnace operation. Upon reaching a set temperature, the resettable thermal switch thereof will open a furnace circuit, but not close the furnace circuit until a second temperature is reached so that oscillations do not occur, thereby preventing rapid and undesirable electrical contact tripping with small variations in temperature of the room.

Referring now to FIGS. 1A and 1B, shown is a resettable thermal switch in the form of a resettable bimetallic thermal switch 10 of the type commonly used for thermostats. All resettable bimetallic thermal switches 10 use a resilient bimetal arm 14 which moves to open and close an electrical contact 12. The resilient bimetal arm 14 is springably biased toward or away from electrical contact, and is composed of two strips of different metals 16, 18, each metal having a different coefficient of thermal expansion.

Returning to the thermostat example and keeping in mind FIGS. 1A and 1B, rising temperature of the room eventually reaches a first predetermined threshold temperature, whereupon the inherent spring force of the bimetal arm, which urges the movable contact component 20 toward contact with the stationary contact component 22, is overcome the differential thermal expansion sufficiently to cause the resilient bimetal arm to curve and trip open the electrical contact 12 (FIG. 1B). Now, as the temperature of the room declines, a second predetermined threshold temperature is reached, whereupon the inherent spring force of the bimetal arm overcomes the differential thermal expansion, and the resilient bimetal arm reverse curves and trips the electrical contact closed. Depending on the direction of the differential expansion curvatures and the spring biasing, the electrical contact may open/close in the opposite manner the example just recounted.

Resettable bimetallic thermal switches operate reliably, but have the drawback that the resilient bimetal arm must be long enough so that at the threshold temperature the curving movement and the opposing inherent spring force are sufficient to trip open the electrical contact.

What remains needed in the art is a resettable thermal switch which does not require the arm length necessary for resilient bimetal arms.

### SUMMARY OF THE INVENTION

The present invention is a resettable thermal switch which overcomes the minimum operational length limitation of a resilient bimetal arm via a principle of operation other than differential thermal expansion. In this regard, the present invention uses the principle that the permeability of a ferromagnetic material is sensitive to temperature variations in the vicinity of the Curie temperature.

The resettable ferromagnetic thermal switch according to the present invention includes a resilient arm having a ferromagnetic aspect associated therewith (inherently or by attachment), an electrical contact including a stationary contact component and a movable contact component located at a distal end of the resilient arm, and a magnet located on one side of the resilient arm. The resilient arm has a predetermined inherent spring force urging the movable contact component toward or away from the stationary contact component depending on whether the electrical contact is to be spring biased closed or spring biased open, respectively. The magnet, preferably of the permanent type, is located to provide a magnetic attraction force with the permeability of the ferromagnetic aspect in opposition to the inherent spring force.

Operatively, as the temperature rises or falls in the vicinity of the Curie temperature, the permeability associated with the ferromagnetic aspect changes. In the case of the temperature rising in the vicinity of the Curie temperature, the permeability decreases because ferromagnetism of the ferromagnetic aspect is changing to paramagnetism. Since the magnetic attraction between the ferromagnetic aspect and the magnet is now less than before, the inherent spring force overcomes the magnetic force and thereupon the electrical contact trips either open or closed, as per the switch design. In the case of the temperature falling in the vicinity of the Curie temperature, the permeability increases because paramagnetism of the ferromagnetic aspect is changing to ferromagnetism. Since the magnetic attraction between the ferromagnetic aspect and the magnet is now greater than before, the magnetic attraction overcomes the inherent spring force and thereupon the electrical contact trips either open or closed, as per the switch design. It will be understood that switch design, taking into account spring force versus magnetic force (which is a function of temperature in the vicinity of the Curie temperature) provides first and second predetermined threshold temperatures for tripping of the electrical contact (the temperature spread therebetween defining a tripping hysteresis), wherein the first and second threshold temperatures may be mutually close or mutually far apart as desired for proper temperature response regulation of a particular circuit, and may straddle or be both on either side of the Curie temperature.

The ferromagnetic aspect may be in the form of ferromagnetic material inherent to the resilient arm, itself, and/or be a separate ferromagnetic material attached thereto. By slight changes to the alloy of the ferromagnetic aspect, different Curie temperatures can be selected for different threshold temperatures for tripping of the electrical contact. Further, changes in the physical arrangement (ie., spring force, magnet strength, permeability of the ferromagnetic aspect, dimensions, operational spacings, and magnetic circuit design) allow for further adjustment of the first and second threshold temperatures after a particular Curie temperature has been established. Since the resilient arm does not have to be very long, a resettable ferromagnetic thermal switch can be made much smaller than a resettable bimetallic thermal switch, a feature important as the trend in the electrical arts toward circuit miniaturization continues unabated.

Accordingly, it is an object of the present invention to provide a resettable thermal switch which operates not on the principle of thermal expansion, but rather on the principle that the permeability of a ferromagnetic material is sensitive to temperature variations in the vicinity of the Currie temperature.

This and additional objects, features and advantages of the present invention will become clearer from the following specification of a preferred embodiment.

### BRIEF DESCRIPTION OF THE DRAWINGS

FIG. 1A is a side view of a prior art resettable bimetallic thermal switch, the electrical contact being shown closed.

FIG. 1B is a side view of the prior art resettable bimetallic thermal switch of FIG. 1A, wherein now the electrical contact is shown open.

FIG. 2 is a side view of a spring biased open resettable ferromagnetic thermal switch according to the present invention, the electrical contact being shown closed.

FIG. 3 is a side view of the resettable ferromagnetic thermal switch of FIG. 2, wherein now the electrical contact is shown open.

FIG. 4 is a top plan view of the normally closed resettable ferromagnetic thermal switch of FIGS. 2 and 3.

FIG. 5 is a side view of an alternative embodiment of the resettable ferromagnetic switch according to the present invention.

FIG. 6 is a side view of a spring biased closed resettable ferromagnetic thermal switch according to the present invention, the electrical contact being shown closed.

FIG. 7 is a side view of the resettable ferromagnetic thermal switch of FIG. 6, wherein now the electrical contact is shown open.

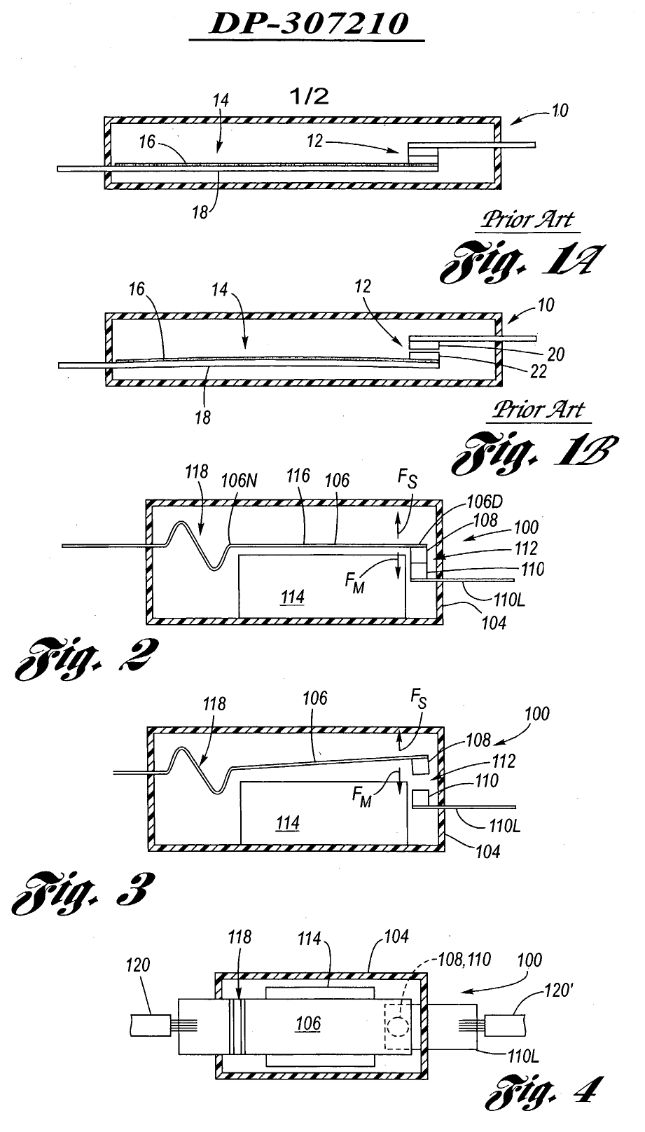

### DESCRIPTION OF THE PREFERRED EMBODIMENT

Referring now to the Drawing, FIGS. 2 through 7 depict examples of a resettable ferromagnetic thermal switch 100, 100′, 100″ according to the present invention. The operative principle in each case, the electrical contact is tripped open and closed based upon whether a temperature sensitive attractive magnetic force overcomes an opposing spring force, wherein the magnetic force is sensitive to temperature variations in the vicinity of a predetermined Curie temperature.

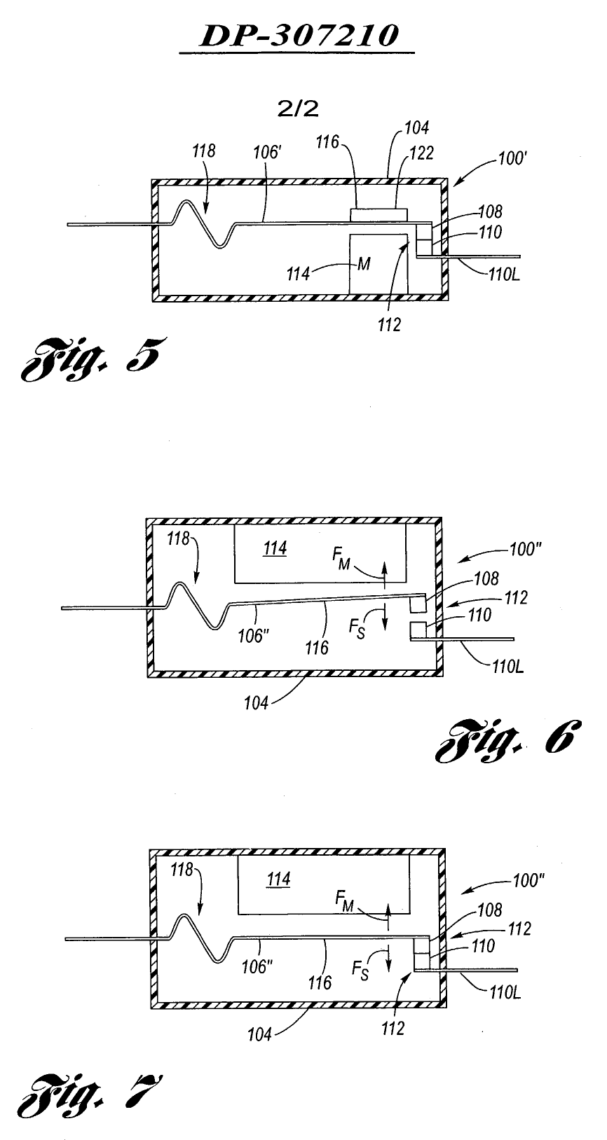

Referring firstly to FIGS. 2 through 4, an example of a spring biased open resettable ferromagnetic thermal switch 100 is depicted. The resettable ferromagnetic thermal switch 100 includes a switch enclosure 104; a resilient arm 106 carrying at a distal end 106D thereof a movable contact component 108; a stationary contact component 110 carried by a stationary leaf 110L, wherein the movable and stationary contact components comprise an electrical contact 112; and a magnet 114 which is preferably in the form of a permanent magnet. As depicted at FIG. 4, the resilient arm 106, the movable and stationary contact components 108, 110 and the stationary leaf 110L are serially connected to wires 120, 120′, which are, in turn connected to an electrical circuit, wherein current of the circuit flows through the resilient arm when the electrical contact is closed.

The resilient arm 106 has an inherent spring biasing in which the spring force F_{S} urges the movable contact component 108 away from contact with the stationary contact component 110. The magnet 114, on the other hand, attracts a ferromagnetic aspect 116 of the resilient arm 106, wherein the magnetic force F_{M} urges the movable contact component 108 toward contact with the stationary contact component 110.

The spring force F_{S} of the resilient arm 106 is a function of resilient bending of the resilient arm (typically defined by the relation F_{S}=−kx, where k is a spring constant and x is a displacement distance) and is essentially independent of changes in temperature. In this regard, the resilient arm 106 may advantageously include a spring portion 118 at a near end 106N thereof.

The magnetic force F_{M} of the magnet 114 attracting the ferromagnetic aspect 116 is dependent upon not only the placement of the magnet 114 relative to the ferromagnetic aspect 116, but also dependent on temperature in the sense that the ferromagnetic aspect 116 has a permeability which varies with temperature in the vicinity of the Curie temperature (typically defined by the relation F_{M}=k′(m₁m₂)/r², where k′ is a constant, m₁ and m₂ are, respectively, the magnetic strength of the magnet and the magnetic field strength associated with the temperature dependent permeability of the ferromagnetic aspect, and r is a distance of separation).

In operation, the resettable ferromagnetic thermal switch 100 is closed as long as the temperature, which may be varied because of changes in ambient temperature and/or because of resistive heating of the resilient arm 106, remains below a predetermined first threshold temperature in the vicinity of the Curie temperature of the ferromagnetic aspect 116, as shown at FIG. 2. In this case the magnetic force F_{M} exceeds the spring force F_{S}. However, when an increasing temperature crosses the first predetermined temperature, then the permeability of the ferromagnetic aspect 116 has reduced to a level that now the magnetic force is weaker than the spring force F_{S} and the electrical contact trips open, as shown at FIG. 3. Later, as the temperature falls and crosses a predetermined second threshold temperature in the vicinity of the Curie temperature of the ferromagnetic aspect 116, the permeability increases and the magnetic force F_{M} increases so that now the magnetic force is stronger than the spring force F_{S} and the electrical contact trips closed, as shown at FIG. 2.

FIG. 5 depicts a variation of the foregoing description, wherein the resettable ferromagnetic thermal switch 100′ has a separate ferromagentic material 122 attached to the resilient arm 106′ which may serve to supplement ferromagnetic material of the resilient arm or provide all the ferromagnetic material of the ferromagnetic aspect 116.

FIGS. 6 and 7 depict a variation of the resettable ferromagnetic thermal switch 100″ wherein all like components have like reference numerals. Now, the resilient arm 106″ has spring biasing which urges the movable contact component 108 toward the stationary contact component 110, and the magnet 114 attracts the ferromagnetic aspect 116 of the resilient arm 106″ in a direction urging the movable contact component 108 away from contact with the stationary contact component 110.

In operation, the resettable ferromagnetic thermal switch 100″ is closed as long as the temperature, which may be varied because of changes in ambient temperature and/or resistive heating of the resilient arm 106, remains above a predetermined first threshold temperature in the vicinity of the Curie temperature of the ferromagnetic aspect 116, as shown at FIG. 7. In this case the spring force F_{S} exceeds the magnetic force F_{M}. However, when a decreasing temperature crosses a first predetermined temperature, then the permeability of the ferromagnetic aspect 116 has increased to a level that now the magnetic force is stronger than the spring force F_{S} and the electrical contact trips open, as shown at FIG. 6. Later, as the temperature increases and crosses a predetermined second threshold temperature in the vicinity of the Curie temperature of the ferromagnetic aspect 116, the permeability of the ferromagnetic aspect decreases and the magnetic force F_{M} decreases to a level that now the magnetic force is weaker than the spring force F_{S} and the electrical contact trips closed, as shown at FIG. 7.

When constructing a resettable ferromagnetic thermal switch according to the present invention, there are a number of factors that need to be considered which affect the first and second threshold temperatures besides the selection of the Curie temperature of the ferromagnetic aspect. Once a Curie temperature has been selected, the following factors will control the first and second threshold temperatures: the magnetic field strength of the magnet; the spacing between the magnet and ferromagnetic aspect; the spring force formed into the resilient arm; the area of the ferromagnetic aspect acted upon by the magnet; the permeability of the ferromagnetic aspect; and the magnetic circuit that contains the magnet and any pole pieces.

With the Curie temperature selected, all of the factors listed above can be adjusting in any combination to change the first and second threshold temperatures to trip the contact somewhere in the vicinity of the Curie temperature, thus attendantly also affecting (per selection of closeness of the first and second threshold temperatures) the electrical contact re-tripping hysteresis. In this regard, while there may be a specific Curie temperature at which the ferromagnetic aspect is said to switch from being ferromagnetic to paramagnetic, the actual change of permeability has a finite slope with temperature. Thus, as the permeability drops with increasing temperature in the vicinity of the Curie temperature, the magnetic force acting against the spring force is also dropping, and as the permeability increases with decreasing temperature in the vicinity of the Curie temperature, the magnetic force acting against the spring force is also increasing. It will be understood that the first and second threshold temperatures may be nearly coincident or be widely separated from each other; and may straddle the Curie temperature or be both on either side of the Curie temperature.

When the spring force exceeds the magnetic force, the switch will trip open (FIG. 3) or trip closed (FIG. 7), depending on whether the switch is of the spring biased open or of the spring biased closed type. For example, a switch of the spring biased open type (FIGS. 2 and 3) when in the tripped open state of the electrical contact, has the ferromagnetic aspect distantly spaced from the magnet, thus increasing the spacing therebetween. As the temperature lowers in the vicinity of the Curie temperature, the permeability of the ferromagnetic aspect increases and the magnetic force increases. But, due to the distant spacing of the ferromagnetic aspect, a second threshold temperature lower than the first threshold temperature must be reached in order to generate enough magnetic force to overcome the spring force. When the magnetic force is greater than the spring force, the ferromagnetic aspect will move toward the magnet, and as the spacing therebetween decreases the magnetic force greatly increases and the contact will trip closed.

The movable and stationary contacts 108, 110 are preferably silver relay contacts, and the stationary leaf 110L is preferably a copper strip. The magnet 114 is preferably a rare earth magnet, for example an Hitachi H-20SV samarium-cobalt rare earth magnet. This magnet will retain 94% of its initial magnetic field strength at temperatures up 220° C. if a heat cure is done after magnetization following the manufacturer's recommendations. The resilient arm is preferably a ferromagnetic leaf spring strip formed of Carpenter “32” type 1 alloy (available through Carpenter Technology, Wyomissing, Pa. 19610) which has a Curie temperature of 199° C. The Curie temperature of the resilient arm may be changed by adjusting the percent of nickel content of the alloy. For example, changing the nickel content of the alloy from 29% to 36% can change the Curie temperature from 20° C. to 300° C. The other above mentioned engineering factors, such as magnetic field strength, magnet spacing, spring force, contact area and permeability of the alloy (of the ferromagnetic aspect), allows a large range of selection of first and second threshold temperatures upon selection of a Curie temperature. Any ordinarily skilled engineer using the disclosure herein should be able to construct a resettable ferromagnetic thermal switch wherein the contact tripping is somewhere, for example, between about 15° C. and about 300° C.

### EXAMPLE I

The materials used for this test were as follows: Hitachi H-20SV samarium-cobalt rare earth magnet 7 mm wide by 9 mm long by 6 mm thick; Carpenter “32” type 1 alloy having a Curie temperature of 199° C. was cut to a width of 5 mm and a length of 23 mm with a thickness of 0.38 mm to provide a resilient arm; silver contacts were removed from a commercial relay were 3 mm. diameter and 0.75 mm thick; and the stationary leaf was made of copper trimmed to 0.75 mm thick by 4 mm wide by 12 mm long. The contacts were peened to the distal end of the resilient arm to provide a movable contact component, and to the stationary leaf to provide the stationary contact component. The spacing between the magnet and resilient arm when the switch closed was 0.75 mm. A force of 25 grams applied above the electrical contact was required to close the electrical contact with no magnet. Under these conditions with over 20 test runs, the resettable ferromagnetic thermal switch electrical contact tripped open at 184° C. within a range of +1° C. to −1° C., and tripped closed at 171° C. within a range of +120 C. to −2° C.

To those skilled in the art to which this invention appertains, the above described preferred embodiment may be subject to change or modification. Such change or modification can be carried out without departing from the scope of the invention, which is intended to be limited only by the scope of the appended claims.

1. A resettable thermal switch, comprising:
a resilient arm having a distal end, wherein said resilient arm has a preset spring bias which provides a spring force;
a ferromagnetic aspect interfaced with said resilient arm, said ferromagnetic aspect having a predetermined Curie temperature;
an electrical contact switchable between an open state and a closed state responsive to movement of said distal end of said resilient arm; and
a magnet located adjacent said ferromagnetic aspect, wherein said magnet magnetically attracts said ferromagnetic aspect so as to provide a magnetic force in a direction opposite to said spring force;
wherein above a first predetermined threshold temperature said magnetic and spring forces are imbalanced so as to cause said electrical contact to be a selected one of closed and open; wherein below a second predetermined threshold temperature said magnetic and spring forces are imbalanced so as to cause said electrical contact to be the other of said selected closed and open; and wherein said first and second predetermined temperatures are selected to be within a range of temperatures over which permeability of said ferromagnetic aspect is sensitive to variation in temperature due to the selection of said Curie temperature.

2. The switch of claim 2, wherein said electrical contact comprises:
a movable contact component connected with said distal end of said resilient arm; and
a stationary contact component, wherein movement of said resilient arm provides selective contact of said movable contact component with said stationary contact component.

3. The switch of claim 2, wherein said ferromagnetic aspect comprises said resilient arm.

4. The switch of claim 2, wherein said spring force urges said movable contact toward said stationary contact, and wherein said magnetic force urges said movable contact away from said stationary contact.

5. The switch of claim 4, wherein said ferromagnetic aspect comprises said resilient arm.

6. The switch of claim 2, wherein said spring force urges said movable contact away from said stationary contact, and wherein said magnetic force urges said movable contact toward said stationary contact.

7. The switch of claim 6, wherein said ferromagnetic aspect comprises said resilient arm.

8. A resettable thermal switch, comprising:
a resilient arm having a distal end, wherein said resilient arm has a preset spring bias which provides a spring force;
a ferromagnetic aspect interfaced with said resilient arm, said ferromagnetic aspect having a predetermined Curie temperature;
an electrical contact comprising a movable contact component connected with said distal end of said resilient arm, and a stationary contact component, wherein movement of said resilient arm provides selective switching of said electrical contact between a closed state wherein said movable and stationary contacts contact each other and an open state in which said movable and stationary contacts are mutually separated; and
a magnet located adjacent said ferromagnetic aspect, wherein said magnet magnetically attracts said ferromagnetic aspect so as to provide a magnetic force in a direction opposite to said spring force;
wherein above a first predetermined threshold temperature said magnetic and spring forces are imbalanced so as to cause said electrical contact to be a selected one of said closed state and said open state; wherein below a second predetermined threshold temperature said magnetic and spring forces are imbalanced so as to cause said electrical contact to be the other of said selected one of said closed state and said open state; and wherein said first and second predetermined temperatures are selected to be within a range of temperatures over which permeability of said ferromagnetic aspect is sensitive to variation in temperature due to the selection of said Curie temperature.

9. The switch of claim 8, wherein said ferromagnetic aspect comprises said resilient arm.
